(19) United States
(12) Patent Application Publication
(10) Pub. No.: US 2024/0257155 A1
(43) Pub. Date: Aug. 1, 2024

(54) AUTOMATED MONITORING AND NOTIFICATION SYSTEM FOR USER CREDENTIALS

(71) Applicant: GOTSKILL PLATFORMS LIMITED, West Perth (AU)

(72) Inventors: Oscar Omegna, Victoria (AU); Grame David Barty, New South Wales (AU); Andrew Charles Kellow McMillan, Claremont (AU)

(73) Assignee: GOTSKILL PLATFORMS LIMITED, West Perth (AU)

(21) Appl. No.: 18/578,909

(22) PCT Filed: Jul. 14, 2022
(86) PCT No.: PCT/AU2022/050742

§ 371 Date: Jan. 12, 2024

(30) Foreign Application Priority Data
Jul. 14, 2021 (AU) 2021902164

(51) Int. Cl. G06Q 30/018

(52) U.S. Cl. CPC G06Q 30/018

(57) ABSTRACT

Systems and methods for credential tracking and notification, and authorising issuers and/or modifiers of digital credentials. Exemplary embodiments may include: computer-implemented methods and systems for the automated monitoring and provision of notifications in relation to user credentials and/or digital user credentials.

### TECHNICAL FIELD

The disclosure relates, generally, to a computer-implemented method and system of monitoring and providing notifications in relation to user credentials. More particularly, the disclosure relates to computer-implemented method and system for the automated monitoring and provision of notifications in relation to user credentials and/or digital user credentials.

### BACKGROUND

Credentials are a well-known way for employers and/or consumers to verify an individual's qualifications in a given field or area of skill and expertise. Credentials can, for example, be certificates awarded by educational institutions (typically in programs that take less than two years to complete), as well as degrees at the associate, bachelor, master and doctorate levels. Industry and trade associations are also in the credentialing business, and offer certifications to demonstrate skill mastery and competencies, typically through some combination of training, assessment and continuing education. State agencies also award licenses to recognise skill attainment such as, for example, the issuance of licences for the operation of various classes of vehicles.

In more recent times, the ubiquitous nature of computing technologies has also resulted in new options for obtaining, validating, and sharing technical skills and proficiencies. As an alternative to attending in-person courses at traditional educational institutions and professional training centres, individuals are able to obtain credentials (or micro-credentials as they are often referred to) through alternative sources including, for example, structured or unstructured and asynchronous eLearning programs using distance learning technology, self-study research without any direct supervision, or various alternative technical learning, training, and testing entities.

These increasing opportunities for individuals to obtain technical skills and proficiencies through such digital means are presenting a range of challenges particularly in relation to issuing, verifying, publishing, sharing, and tracking the collection of credentials associated with a specific individual. Many individuals and institutions no longer rely on physical certificates such as diplomas, transcripts, certification statements, and physical licenses, to verify the authenticity of an individual's proficiencies or qualifications. Instead, there has been an increasing demand for the issuance of digital credentials (or digital badges) to qualifying individuals, with these digital credential earners using the digital credentials to certify the skills or qualifications that the earner obtained.

Since digital representations of credentials are often far easier to alter, modify, or forge than their physical counterparts, there is a requirement for secure channels of issuance and verification of the digital credentials from trusted providers. Such authentication measures given employers and/or consumers confidence that the credentials shared with them are in fact valid and issued by the institution and or organisation/association in question. However, since many credentials (including digital credentials and micro-credentials) have an expiry date, and therefore a predefined validity period unless otherwise renewed, there is also the need for a system to manage an individual's credentials and to provide notifications to nominated third parties when credentials either expire, become invalid, or are withdrawn.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

The present disclosure relates to a credential tracking and notification system comprising:
a digital credential template owner device, comprising:
   a processing unit comprising one or more processors;
   one or more network interfaces configured to transmit secure data to a digital credential platform server; and
   memory coupled with and readable by the processing unit and storing therein a set of instructions which, when executed by the processing unit, causes the digital credential template owner device to:
      transmit one or more digital credential templates to the digital credential platform server:
      receive requests from the digital credential platform server to confirm authorised issuers of digital credentials based on one or more of the digital credential templates; and
      in response to said requests, transmit secure data confirming one or more digital credential issuers as authorised issuers and/or modifiers of digital credentials based on one or more of the digital credential templates:
a digital credential issuer device, comprising:
a processing unit comprising one or more processors;
one or more network interfaces configured to transmit secure data to the digital credential platform server; and
memory coupled with and readable by the processing unit and storing therein a set of instructions which, when executed by the processing unit, causes the digital credential issuer device to:
   respond to requests from the digital credential platform server to request permission to update the status of digital credentials based on one or more of the digital credential templates associated with one or more digital credential template owners;
   receive responses to said requests from the digital credential platform server, said responses confirming a digital credential issuer associated with the digital credential issuer device as an authorised issuer and/or modifier of digital credentials based on one or more of the digital credential templates associated with one or more digital credential template owners;
   access, from the digital credential platform server, a first digital credential template for which the digital credential issuer is authorised to issue and/or modify digital credentials;
   determine that a first credential receiver is eligible to receive a digital credential based on the first digital credential template;
   update the status of a first digital credential based on the first digital credential template and data confirming a status change of the first digital credential; and
   transmit data confirming the status of the first digital credential to the first credential receiver, and to the digital credential platform server; and
a digital credential platform server, comprising:
   a processing unit comprising one or more processors;
   one or more network interfaces configured to transmit secure data to the digital credential platform server; and
   memory coupled with and readable by the processing unit and storing therein a set of instructions which, when executed by the processing unit, causes the digital credential platform server to:
      receive one or more digital credential templates, including the first digital credential template, from the digital credential template owner device associated with a digital credential template owner, the first digital credential template corresponding to an educational or training certification defined by the digital credential template owner:
      store the received one or more digital credential templates in a secure storage of the digital credential platform server:
      transmit, to the digital credential issuer device associated with the digital credential issuer, an automated status request requesting the current status of digital credentials based on the first digital credential template:
      receive, in response to said transmitted request, from the digital credential issuer device, data confirming the status change of the first digital credential, the first digital credential representing completion of the educational certification or training course by a credential recipient:
      transmit, to the digital credential template owner device, a request corresponding to the automated status request issued to the digital credential issuer to modify digital credentials based on the first digital credential template:
      receive, in response to said transmitted request, from the digital credential template owner device, authorisation data permitting the digital credential issuer to issue and/or modify digital credentials based on the first digital credential template:
      in response to the received authorisation data, grant the digital credential issuer device access to the first digital credential template;
      transmit a communication to a first receiver device associated with the first credential receiver, in response to receiving the data from the digital credential issuer device confirming the current status of the first digital credential;
      output a user interface during a network session with the first credential receiver device, the user interface including a notification regarding the current status of the first digital credential; and
      store the data corresponding to the first digital credential, including data indicating the current status of the first digital credential, in the secure storage of the digital credential platform server.

The memory of the digital credential platform server storing therein further instructions which, when executed by the processing unit, may cause the digital credential platform server to:
receive, from the digital credential template owner device, additional authorisation data permitting the digital credential issuer to be named as a providing entity within digital credentials issued by the digital credential issuer based on the first digital credential template;
store, in association with the first digital credential, data indicating that the digital credential issuer was the provider of the first digital credential;
receive a request for the first digital credential from a client device; and
retrieve and output the data corresponding to the first digital credential, including the data indicating that the digital credential issuer was the provider of the first digital credential, in response to the request.

The memory of the digital credential platform server storing therein further instructions which, when executed by the processing unit, may cause the digital credential platform server to:
receive, from a credential endorser device, additional authorisation data permitting a first a credential endorser to be named as an endorsing entity for digital credentials issued and/or modified based on the first digital credential template;
store, in association with the first digital credential, data indicating that the endorsing entity endorses the first digital credential;
receive a request for the first digital credential from a client device; and
retrieve and output the data corresponding to the first digital credential, including the data indicating that the endorsing entity endorses the first digital credential, in response to the request.

The received selection of the first credential receiver may be a selection to accept the first digital credential, and wherein the memory of the digital credential platform server stores further instructions which, when executed by the processing unit, causes the digital credential platform server to:
in response to the acceptance of the first digital credential by the first credential receiver, generate a uniform resource locator (URL) associated with the first digital credential.

The digital credential platform server may receive a plurality of digital credential templates from the digital credential template owner device, including the first digital credential template and a second digital credential template, and wherein the memory of the digital credential platform server storing therein further instructions which, when executed by the processing unit, causes the digital credential platform server to:
receive, from the digital credential template owner device, second authorisation data denying permission to the digital credential issuer to issue and/or modify digital credentials based on the second digital credential template; and
in response to the received authorisation data and second authorisation data, grant the digital credential issuer device access to the first digital credential template but prevent the digital credential issuer device from accessing the second digital credential template.

The memory of the digital credential platform server storing therein further instructions which, when executed by the processing unit, may cause the digital credential platform server to:
receive, from the digital credential issuer device, additional data confirming an issuance and/or modification of a second digital credential based on a second digital credential template, wherein the first and the second digital credentials are received from the same digital credential issuer device, but wherein the first digital credential template is associated with a different digital credential template owner than the second digital credential template.

The memory of the digital credential platform server storing therein further instructions which, when executed by the processing unit, may cause the digital credential platform server to:
identify a particular flag within the data received from the digital credential issuer device, confirming the issuance and/or modification of the first digital credential to the first credential receiver;
in response to the identification of the particular flag, generate a uniform resource locator (URL) associated with the first digital credential, wherein the URL is generated without receiving an indication of acceptance of the first digital credential by the first credential receiver; and
transmit the generated URL associated with the first digital credential to the digital credential issuer device.

The memory of the digital credential platform server storing therein further instructions which, when executed by the processing unit, may cause the digital credential platform server to:
receive, from the digital credential template owner device, a template update for the first digital credential template; and
update the data corresponding to the first digital credential in the secure storage of the digital credential platform server, based on the template update received for the first digital credential template.

Storing the data corresponding to the first digital credential may comprise storing an expiration date associated with the first digital credential, and wherein the memory of the digital credential platform server storing therein further instructions which, when executed by the processing unit, causes the digital credential platform server to:
monitor the expiration date associated with the first digital credential; and
in response to determining that the expiration date has passed, update the data corresponding to the first digital credential in the secure storage of the digital credential platform server to indicate that the first digital credential is expired.

The memory of the digital credential platform server storing therein further instructions which, when executed by the processing unit, may cause the digital credential platform server to:
receive, from a client device associated with an endorsing entity, an update to an endorsement of the first digital credential template; and
update the data corresponding to the first digital credential in the secure storage of the digital credential platform server, based on the update to the endorsement of the first digital credential template.

The present disclosure also relates to a method of authorising issuers and/or modifiers of digital credentials, comprising:
receiving, by a digital credential platform server, one or more digital credential templates, including a first digital credential template, from a digital credential template owner device associated with a digital credential template owner, the first digital credential template corresponding to an educational or training certification defined by the digital credential template owner;
storing the received one or more digital credential templates in a secure storage of the digital credential platform server;
transmitting, by the digital credential platform server and to the digital credential template owner device, an automated status request requesting the current status of digital credentials based on the first digital credential template;
receiving, by the digital credential platform server, in response to said transmitted request, authorisation data permitting the digital credential issuer to issue and/or modify digital credentials based on the first digital credential template;
granting, by the digital credential platform server, the digital credential issuer device access to the first digital credential template, in response to the received authorisation data;
receiving, by the digital credential platform server, from the digital credential issuer device, data confirming issuance and/or modification of a first digital credential to a first credential receiver, the first digital credential representing completion of the educational certification or training course by the first credential receiver;
in response to receiving the data from the digital credential issuer device confirming the issuance and/or modification of the first digital credential, transmitting, by the digital credential platform server, a communication to a first receiver device associated with the first credential receiver;
outputting a user interface during a network session with the first credential receiver device, the user interface including a notification regarding the current status of the first digital credential; and
storing the data corresponding to the first digital credential, including data indicating the current status of the first digital credential, in the secure storage of the digital credential platform server.

The method of authorising issuers and/or modifiers of digital credentials may further comprise:
receiving, from the digital credential template owner device, additional authorisation data permitting the digital credential issuer to be named as a providing entity within digital credentials issued by the digital credential issuer based on the first digital credential template;
storing, in association with the first digital credential, data indicating that the digital credential issuer was the provider of the first digital credential;
receiving a request for the first digital credential from a client device; and
retrieving and outputting the data corresponding to the first digital credential, including the data indicating that the digital credential issuer was the provider of the first digital credential, in response to the request.

The method of authorising issuers and/or modifiers of digital credentials may further comprise:
receiving, from a credential endorser device, additional authorisation data permitting a first a credential endorser to be named as an endorsing entity for digital credentials issued based on the first digital credential template;
storing, in association with the first digital credential, data indicating that the endorsing entity endorses the first digital credential;
receiving a request for the first digital credential from a client device; and retrieving and outputting the data corresponding to the first digital credential, including the data indicating that the endorsing entity endorses the first digital credential, in response to the request.

The received selection of the first credential receiver may be a selection to accept the first digital credential, the method further comprising:
generating a uniform resource locator (URL) associated with the first digital credential, in response to the acceptance of the first digital credential by the first credential receiver.

The digital credential platform server may receive a plurality of digital credential templates from the digital credential template owner device, including the first digital credential template and a second digital credential template, and wherein the method further comprises:
receiving, from the digital credential template owner device, second authorisation data denying permission to the digital credential issuer to issue and/or modify digital credentials based on the second digital credential template; and
in response to the received authorisation data and second authorisation data, granting the digital credential issuer device access to the first digital credential template but preventing the digital credential issuer device from accessing the second digital credential template.

The method of authorising issuers and/or modifiers of digital credentials may further comprise:
receiving, from the digital credential issuer device, additional data confirming an issuance and/or modification of a second digital credential based on a second digital credential template, wherein the first and the second digital credentials are received from the same digital credential issuer device, but wherein the first digital credential template is associated with a different digital credential template owner than the second digital credential template.

The method of authorising issuers and/or modifiers of digital credentials may further comprise:
identifying a particular flag within the data received from the digital credential issuer device, confirming the issuance and/or modification of the first digital credential to the first credential receiver;
in response to the identification of the particular flag, generating a uniform resource locator (URL) associated with the first digital credential, wherein the URL is generated without receiving an indication of acceptance of the first digital credential by the first credential receiver; and
transmitting the generated URL associated with the first digital credential to the digital credential issuer device.

The method of authorising issuers and/or modifiers of digital credentials may further comprise:
receiving, from the digital credential template owner device, a template update for the first digital credential template; and
updating the data corresponding to the first digital credential in the secure storage of the digital credential platform server, based on the template update received for the first digital credential template.

Storing the data corresponding to the first digital credential may comprise storing an expiration date associated with the first digital credential, and wherein the method further comprises:
monitoring the expiration date associated with the first digital credential; and
in response to determining that the expiration date has passed, updating the data corresponding to the first digital credential in the secure storage of the digital credential platform server to indicate that the first digital credential is expired.

The method of authorising issuers and/or modifiers of digital credentials may further comprise:
receiving, from a client device associated with an endorsing entity, an update to an endorsement of the first digital credential template; and
updating the data corresponding to the first digital credential in the secure storage of the digital credential platform server, based on the update to the endorsement of the first digital credential template.

### BRIEF DESCRIPTION OF DRAWINGS

Embodiments of the present invention will now be described with reference to the accompanying drawings. These embodiments are given by way of illustration only and other embodiments of the invention are also possible. Consequently, the particularity of the accompanying drawings is not to be understood as superseding the generality of the preceding description. In the drawings:

FIG. 1 is a schematic block diagram illustrating a credential tracking and notification system in accordance with a representative embodiment of the present invention;

FIG. 2 is a schematic block diagram illustrating a web-based credential tracking and notification system in accordance with an alternative embodiment of the present invention.

FIG. 3 is a block diagram illustrating an example digital credential tracking and notification system, according to one or more embodiments of the disclosure.

FIG. 4 is a flow diagram illustrating an example process of authorising digital credential issuers to generate digital credentials based on particular digital credential templates, according to one or more embodiments of the disclosure:

FIG. 5 is a flow diagram illustrating an example process of generating, storing, modifying, and provisioning digital credentials based on digital credential templates, according to one or more embodiments of the disclosure; and

FIG. 6 is a flow diagram illustrating an example process of initiating the acceptance, modification and sharing of digital credentials, based on interactions with digital credential receivers, according to one or more embodiments of the disclosure.

### DESCRIPTION OF EMBODIMENTS

The ensuing description provides illustrative embodiment(s) only and is not intended to limit the scope, applicability or configuration of the disclosure. Rather, the ensuing description of the illustrative embodiment s) will provide those skilled in the art with an enabling description for implementing a preferred exemplary embodiment. It is understood that various changes can be made in the function and arrangement of elements without departing from the spirit and scope as set forth in the appended claims.

Various techniques (e.g., systems, methods, computer-program products tangibly embodied in a non-transitory machine-readable storage medium, etc.) are described herein for generating and managing digital credentials using a digital credential platform in communication with various digital credential template owners and digital credential issuers. In some embodiments, one or more digital credential templates may be received by a digital credential platform server, from various template owner systems. Template owners may correspond to entities responsible for controlling the content and definition of a digital credential, such as an educational institution or other professional training organisation. The digital credential platform server also receive and coordinate requests and responses between the digital credential template owners and a set of digital credential issuers, to determine which digital credential issuers are authorised to issue and/or modify digital credentials based the digital credential templates to which they relate. After receiving authorisation data from a template owner permitting a particular digital credential issuer to issue and/or modify digital credentials based on one or more particular digital credential templates, the digital credential platform server may provide the authorised issuers with access to the particular digital credential templates and the functionality to generate (or issue) new digital credentials to users, or to modify those digital credentials, based on any of the particular digital credential templates. After issuance of a new digital credential by an authorised issuer, the digital credential platform server may store the digital credential and initiate communication with the associated template owner and/or the digital credential receiver. This, in various embodiments described herein, digital credentials issued via a digital credential platform server may be associated with one or more separate providers, issuers, and/or receivers, as well as one or more credential endorsers. After the issuance of a digital credential, the digital credential platform server may further verify, track, and update digital credentials based on additional data received from one or more of these various entities.

Additional techniques described herein relate to tracking, analysing, and reporting data metrics for issued digital credentials. In certain embodiments, one or more digital credential templates may be received by a digital credential platform server, from various template owner systems. The digital credential platform server may store the digital credential templates, as well as data corresponding to any issued digital credentials based on the templates. Following the issuance of digital credentials, the digital credential platform server may intiate and/or receive interactions with digital credential receivers, digital credential template owners, digital credential issuers, and various additional systems, relating to the issued digital credentials. For example, digital credential platform server may provide functionality for receivers to accept or reject digital credentials, and shared digital credentials via various communication media and platforms. The digital credential platform server also may receive and track digital credential views by various external systems. In responses to a request for data metrics and/or analysis from a client device, the digital credential platform server may determine a subset of digital credentials associated with the request, and then transmit data relating to the subset of digital credentials, including data metrics such as the issue date, status, and expiration date of the digital credentials, the issuing and providing entities, and metrics relating to acceptances, shares, views, etc.

Representative embodiments of the present invention relate to a computer implemented credential tracking and notification method and system.

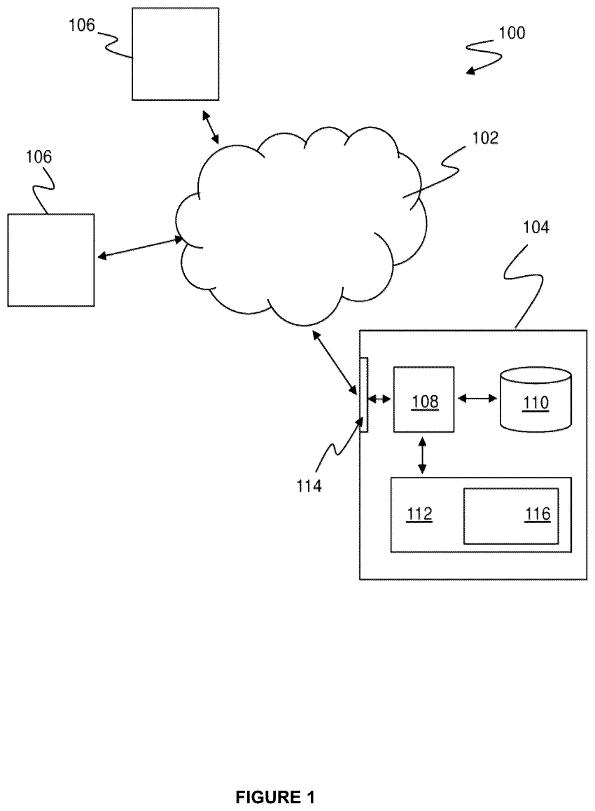

FIG. 1 is a schematic diagram illustrating a system 100 within which embodiments of the present invention may be implemented.

The system 100 uses a communications network 102, e.g. the Internet, to facilitate a computer implemented method and system of credential tracking and notification.

In the exemplary embodiment 100, a server 104 (e.g., digital credential platform server) executes a web server software application for provision of services to user devices 106. Communication between the digital credential platform server 104 and the devices 106 is thus conveniently based upon standard hypertext transfer protocol (HTTP) and/or secure hypertext transfer protocol (HTTPS).

The devices 106 (i.e. ‘users’) may be fixed devices such as desktop computers and/or, preferably, mobile devices such a smart phones, tablets, notebook computers and so forth. As will be appreciated by persons skilled in the communication arts, various mechanisms and technologies are available to provide access to the Internet 102 from fixed and mobile devices 106, and all such technologies fall within the scope of the present invention.

The server 104 may generally comprise one or more computers, each of which includes at least one microprocessor 108. The number of computers and processors 108 generally depends upon the required processing capacity of the system, which in turn depends upon the number of concurrent user devices 106 which the system is designed to support. In order to provide a high-degree of scalability, for example when supporting a global user base, the server 104 may utilise cloud-based computing resources, and/or may comprise multiple server sites located in different geographical regions. The use of a cloud computing platform, and/or multiple server sites, enables physical hardware resources to be allocated dynamically in response to service demand. These and other variations, regarding the server computing resources, will be understood to be within the scope of the present invention, although for simplicity the exemplary embodiments described herein employ only a single server computer 104 with a single microprocessor 108.

The microprocessor 108 is interfaced to, or otherwise operably associated with, a non-volatile memory/storage device 110. The non-volatile storage 110 may be a hard-disk drive, and/or may include solid-state non-volatile memory such as read-only memory (ROM), flash memory, or the like. The microprocessor 108 is also interfaced to volatile storage 112, such as random access memory (RAM), which contains program instructions and transient data relating to the operation of the server 104.

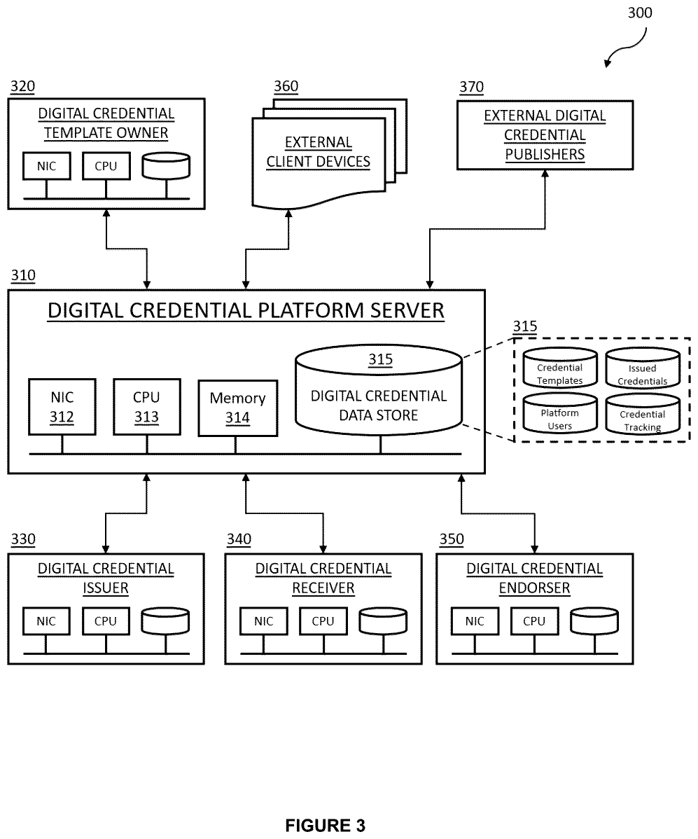

In a conventional configuration, the storage device 110 maintains known program and data content relevant to the normal operation of the server system 104, including operating systems, programs and data, as well as other executable application software necessary to the intended functions of the server 104. In the embodiment shown, the storage device 110 also contains program instructions which, when executed by the processor 108, enable the server computer 104 to perform operations relating to the implementation of services and facilities embodying the present invention, such as are described in greater detail below with reference to FIGS. 3 to 6. In operation, instructions and data held on the storage device 110 are transferred to volatile memory 112 for execution on demand.

The microprocessor 108 is operably associated with a network interface 114 in a conventional manner. The network interface 114 facilitates access to one or more data communications networks, including the Internet 102, to enable communication between the server 104 and the user devices 106. In use, the volatile storage 112 includes a corresponding body of 116 of program instructions configured to perform processing and operations embodying features of the present invention, for example as described below with reference to FIGS. 3 to 6.

For example, the program instructions 116 include instructions embodying a web server application. Data stored in the non-volatile 110 and volatile 112 storage comprises web-based code for presentation and/or execution on user devices 106, such as HTML and/or JavaScript code, for facilitating a web-based implementation of a service for allocating skill levels to workers within a common trade speciality.

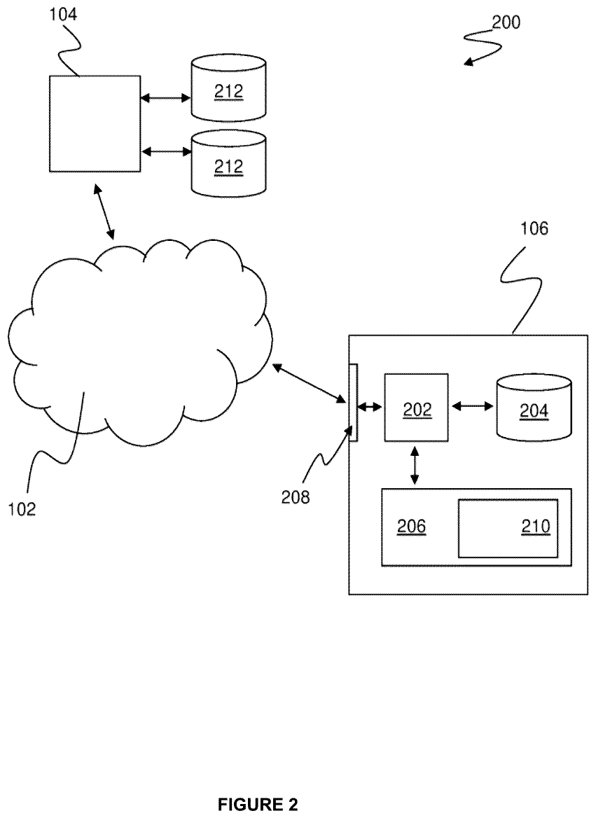

An alternative implementation 200, again by way of example only, is illustrated in the schematic diagram of FIG. 2. In this alternative embodiment, at least a portion of the executable program code implementing the system is executed within the user devices 106. As shown, each user device is typically a computing device, including at least one microprocessor 202, non-volatile storage 204 and volatile storage 206. Each user device 106 also has a network interface 208, operably associated with the microprocessor 202 in a conventional manner. Accordingly, the user devices 106 are able to conduct computational processing by execution of programs stored locally, in the volatile 206 and non-volatile 204 storage, and/or downloaded via the Internet 102 through the network interface 208.

In the embodiment 200 the server 104 may be in communication with one or more databases 212, which may contain records relating to the operation of the payment transaction service, and additionally may include downloadable software components for execution on the user device 106. For example, a portion of the system may be implemented via program instructions developed in a language such as Java, or some other suitable programming language, which execute on the user device 106 in order to retrieve data via the server 104, and implement some or all of the functionality of the exemplary system of application deployment as described below with reference to FIGS. 3 to 6.

User-side implementations may also include downloadable and executable code in the form of browser plugins, such as ActiveX controls for Windows-based browsers, and/or other applets or apps configured for execution within a browser environment or within a smartphone operating system environment, such as an Apple iOS environment or an Android environment.

FIG. 3 of the drawings shows a block diagram illustrating an example of a digital credential tracking and notification system 300 for generating, managing, and tracking digital credential templates and digital credentials. As shown in this example, a digital credential tracking and notification system 300 may include a digital credential platform server 310 configured to communicate with various other digital credential systems 320-380. As discussed below, the digital credential platform server 310 (or platform server 310) may receive and store digital credential templates from various digital credential template owner systems 320. Systems 320 may correspond to the computer servers and/or devices of an educational institution or other professional training organisation, which has the primary responsibility for defining a digital credential template and controlling the content and requirements for users to receive a digital credential from the organisation. The digital credential tracking and notification system 300 may include one or more digital credential issuer systems 330. As discussed below; each issuer system 330 may communicate with the platform server to request and receive access to issue and/or modify digital credentials based on specific digital credential templates. The platform server 310 may process template access requests from the credential issuer systems 330, permitting or denying a specific system 330 to generate (or issue), or modify, a digital credential based on a specific digital credential template.

As used herein, a digital credential template (or digital badge template) may refer to an electronic document or data structure storing a general (e.g., non-user specific) template or description of a specific type of digital credential that may be issued to an individual. Within the context of the present disclosure, a credential may be any recognition held by an individual or organisation that provides evidence of a capability, entitlement, or ownership. Illustrative examples of such credentials include, but are not limited to, insurance policies, corporate licences, leases, evidence of title, registrations, and business/company registration numbers. Digital credential templates may include, for example, a description of the skills, proficiencies, and/or achievements that the digital credential represents. This description may take the form of diploma data, certification data, and/or license data, including the parent organisation (i.e., the digital credential template owner) responsible for creating and defining the digital credential template. Examples of digital credential templates include templates for various technology certifications, licensure exams, professional tests, training course completion certificates, and the like. In contrast to a digital credential template, a digital credential (or digital badge) may refer to an instance of an electronic document or data structure, generated for a specific individual (i.e., the credential receiver), and based on a digital credential template. Thus, a digital credential document or data structure may be based on a corresponding digital credential template, but may be customised and populated with user-specific information such as individual identification data (e.g., name, email address, and other user identifiers), credential issuance data (e.g., issue date, geographic location of issuance, authorised issuer of the credential, etc.), and links or embedded data that contain the specific user's supporting documentation or evidence relating to the credential.

As shown in this example, the system 300 also may include a digital credential receiver system 340 and a digital credential endorser system 350. The digital credential receiver system 340 may be a computing device associated with a credential receiver (or credential earner), for example, an individual user of an electronic learning system, professional training system, online certification course, etc. As discussed below, credential receivers may access the platform server 310 via systems 340 to accept or reject newly issued or modified digital credentials, review and update their own set of previously earned digital credentials, as well as to publish (or share) their digital credentials via communication applications or publishing platforms such as social media systems. Digital credential endorser system 350 may be a computing system associated with an endorsing entity, such as an educational institution, business, or technical organisation that has chosen to review and endorse a specific digital credential template. The platform server 310 may receive and track the endorsements received from systems 350, and may associate the endorsements with the user-specific digital credentials issued based on the endorsed templates. The platform server 310 may provide graphical and/or programmatic interfaces to support interactions with different endorser systems 350.

In some cases, credential endorsers may initiate an interaction with the platform server 310, which may allow the credential endorsers to browse, review; and select one or more templates to endorse. In these cases, the platform server 310 may identify the template owners of the selected templates, and transmit requests to the corresponding owner systems 310 to confirm the endorsements. Template owner systems 310 may respond by accepting the endorsement, in which case the template data is updated within the data store 315, or rejecting the endorsement, in which case the stored template data is not updated. Additionally or alternatively, template owners and/or authorised issuers may initiate the interactions by making requests for endorsements from specific endorsers. In these cases, the platform server 310 may support interfaces that allow template owners and/or authorised issuers to select one or more of their associated templates, and then browse and select from a list of registered endorsers to send endorsement requests. In response, the platform server 310 may identify the endorser systems 350 of the selected endorsers and transmit endorsement requests. The endorser systems 350 of the selected endorsers may respond by agreeing to the endorse the template, in which case the template data is updated within the data store 315, or refusing to endorse, in which case the stored template data is not updated.

Although these examples describe endorsements of templates, the same techniques may be used to request, receive, and track endorsements of specific authorised issuers and/or endorsements of certain template-issuer combinations. For example, an endorser via an endorser system 350 may initiate or respond to communications from the platform server 310 to provide an endorsement of all digital credentials issued by a particular authorised issuer, regardless of the template. In other examples, an endorser may interact with the interfaces of the platform server 310 to provide an endorsement for all of the digital credentials issued and/or modified by a particular authorised issuer based on a particular template, whereas the same endorser might not endorse other credentials issued and/or modified by other authorised issuers based on the same particular template.

Additionally, the platform server 310 also may allow endorser systems 350 to endorse various templates (and/or template-issuer combinations) with an endorsement amount representing an endorsement value or strength. For instance, an endorsing entity such as an occupational certification organisation may wish to endorse a certain credential template, indicating in the endorsement that the corresponding digital credentials count towards N number of certification credits or points. As another example, an endorsing entity may endorse a first template-issuer combination with a first endorsement level (e.g., Regular Endorsement), and a second template-issuer combination with a first endorsement level (e.g., Highest Endorsement). In these examples, the platform server 310 may support the interactions with the endorser systems 350, allowing endorsers to select templates, issuers, and templates-issuer combinations to endorse, as well as select endorsement levels/values/strengths for each endorsement. The platform server 310 may save the endorsement data in the appropriate tables of data store 315, and may retrieve and apply the endorsement when providing digital credential data/views.

Additionally, the digital credential tracking and notification system 300 in this example includes a number of external client devices 360 and external digital credential publishers 370. External client devices 360 may correspond to computing systems of third-party users that may interact with the platform server 310 to initiate various functionality or retrieve data relating to templates and/or digital credentials managed by the platform 310. For example, a client device 360 may query the platform server 310 for data metrics and/or analyses relating to a subset of digital credentials stored in the digital credential data store 315. The third-party systems 360 also may provide data to the platform server 310 that may initiate updates to the templates and/or digital credentials stored in the data store 315. External digital credential publishers 370 may correspond to third-party systems configured to receive digital credential data from the platform 310 and publish (or present) the digital credential data to users. Examples of publishers 370 may include social media website and systems, digital badge wallets, and/or other specialised servers or applications configured to store and present views of digital badges to users.

In various embodiments described herein, the generation, management, and modification of digital credentials, as well as the tracking and reporting of digital credential data, may be performed within content distribution networks (CDNs) (not shown), such as eLearning, professional training, and certification systems. For example, within the context of an eLearning CDN, a content management server (not shown) or other CDN server (not shown) may create and store digital credential templates to describe and define various proficiencies, achievements, or certifications supported by the eLearning CDN (not shown). Additionally or alternatively, a content management server (not shown) or other servers of an eLearning CDN (not shown) may issue and/or modify digital credentials to users, based on its own digital credential templates and/or templates received from other systems or CDNs. Further, in some implementations, an eLearning CDN (not shown) may be configured to include a digital credential platform server 310 to store and manage templates and digital credentials between separate systems within the CDN (not shown). Thus, in various different implementations, the content management server(s) (not shown) of a CDN (not shown) may incorporate one, two, or all three of a digital credential template owner system 320, a digital credential issuer system 330, and/or a digital credential platform server 310. In such embodiments, the various components and functionalities described herein for the platform server 310, owner system 320, and/or issuer system 330 all may be implemented within one or more content management servers (not shown) (and/or other servers) of an eLearning or professional training CDN (not shown). In other examples, a digital credential platform server 310 may be implemented using one or more computer servers, and other specialised hardware and software components, separately from any other CDN components such as content servers (not shown), content management servers (not shown), data store servers (not shown), and the like. In these examples, the digital credential platform server 310 may be configured to communicate directly with related systems 320-370, or indirectly through content management servers (not shown) and/or other components and communications networks of the CDN (not shown).

In order to perform these features and other functionality described herein, each of the components and sub-components discussed in the example digital credential tracking and notification system 300 may correspond to a single computer server or a complex computing system including a combination of computing devices, storage devices, network components, etc. Each of these components and their respective subcomponents may be implemented in hardware, software, or a combination thereof. Certain systems 320-370 may communicate directly with the platform server 310, while other systems 320-370 may communicate with the platform server 310 indirectly via one or more intermediary network components (e.g., routers, gateways, firewalls, etc.) or other devices (e.g., content management servers (not shown), content servers (not shown), etc.). Although the different communication networks and physical network components have not been shown in this example so as not to obscure the other elements depicted in the figure, it should be understood that any of the network hardware components and network architecture designs may be implemented in various embodiments to support communication between the systems, servers, and devices in the digital credential tracking and notification system 300. Additionally, different systems 320-370 may use different networks and networks types to communicate with the platform server 310, including one or more telecommunications networks, cable networks, satellite networks, cellular networks and other wireless networks, and computer-based IP networks, and the like. Further, certain components within the digital credential tracking and notification system 300 may include special purpose hardware devices and/or special purpose software, such as those included in I/O subsystem 311 and memory 314 of the platform server 310, as well as those within the memory of the other systems 320-370, and the digital credential data store 315 maintained by the platform server 310, discussed below.

Although the various interactions between the platform server 310 and other systems 320-370 may be described below in terms of a client-server model, it should be understood that other computing environments and various combinations of servers and devices may be used to perform the functionality described herein in other embodiments. For instance, although the requests/responses to determine the authorised issuers and/or modifiers 330 for specific digital credential templates, the generation of digital credentials, and the retrieval and presentation of digital credential tracking and reporting data, may be performed by a centralised web-based platform server 310 in collaboration with various client applications at the other systems 320-370 (e.g., web browser applications or standalone client software), in other cases these techniques may be performed entirely by a specialised digital credential platform server 310, or entirely by one or more digital credential tools (e.g., software services) executing on any one of the systems 320-370. In other examples, a client-server model may be used as shown in system 300, but different functional components and processing tasks may be allocated to the client-side or the sever-side in different embodiments. Additionally, the digital credential data store 315 may be implemented as separate servers or storage systems in some cases, and may use independent hardware and software service components. However, in other implementations, some or all of the digital credential data store 315 may be incorporated into the platform server 310 (as shown in this example) and/or may be incorporated into various other systems 320-370.

In some embodiments, each of the systems 320-370 that collaborate and communicate with the platform server 310 may be implemented as client computing systems, such desktop or laptop computers, smartphones, tablet computers, and other various types of computing devices, each of which may include some or all of the hardware, software, and networking components discussed above. Specifically, any of client systems 320-370 may be implemented using any computing device with sufficient processing components, memory and software components, and I/O system components for interacting with users and supporting the desired set of communications with the platform server 310, as described herein. Accordingly, client systems 320-370 may include the necessary hardware and software components to establish the network interfaces, security and authentication capabilities, and capabilities for transmitting/receiving digital credential templates and digital credentials, digital credential data requests/responses to the platform server 310, etc. Each client system 320-370 may include an I/O subsystem, network interface controller, a processing unit, and memory configured to operate client software applications. The digital credential platform server 310 may be configured to receive and execute various programmatic and graphical interfaces for generating, managing, and tracking issued digital credentials, in collaboration with the various client systems 320-370. Accordingly, each client systems 320-370 may include an I/O subsystem 311 having hardware and software components to support a specific set of output capabilities (e.g., LCD display screen characteristics, screen size, colour display, video driver, speakers, audio driver, graphics processor and drivers, etc.), and a specific set of input capabilities (e.g., keyboard, mouse, touchscreen, voice control, cameras, facial recognition, gesture recognition, etc.). Different client systems 320-370 may support different input and output capabilities within their I/O subsystems, and thus different types of user interactions, and platform server 310 functionality may be compatible or incompatible with certain client systems 320-370. For example, certain types of digital credential generation and search functionality may require specific types of processors, graphics components, network components, or I/O components in order to be optimally designed and constructed using a client system 320-370.

In some embodiments, the digital credential platform server 310 may generate and provide software interfaces (e.g., via a web-based application, or using other programmatic or graphical interface techniques) used by the various client systems 320-370 to perform the various digital credential management functionality described herein. In response to receiving inputs from a client system 320-370 corresponding to digital credentials, templates, credential search requests and criteria, etc., the platform server 310 may access the underlying digital credential data store 315 perform the various functionality described herein. In other to perform the tasks described herein, platform server 310 may include components such as network interface controllers 312, processing units 313, and memory 314 configured to store server software, handle authentication and security, and to store, analyse, and manage the digital credentials, templates, and credential tracking data stored within the digital credential data store 315. As shown in this example, the digital credential data store 315 may be implemented as separate dedicated data stores (e.g., databases, file-based storage, etc.) used for storing digital credential template objects, issued digital credentials, credential tracking data, and authorised user/role data. The platform server 310 and data store 315 may be implemented as separate software (and/or storage) components within a single computer server 310 in some examples, while in other examples may be implemented as separate computer server systems having separate dedicated processing units, storage devices, and/or network components.

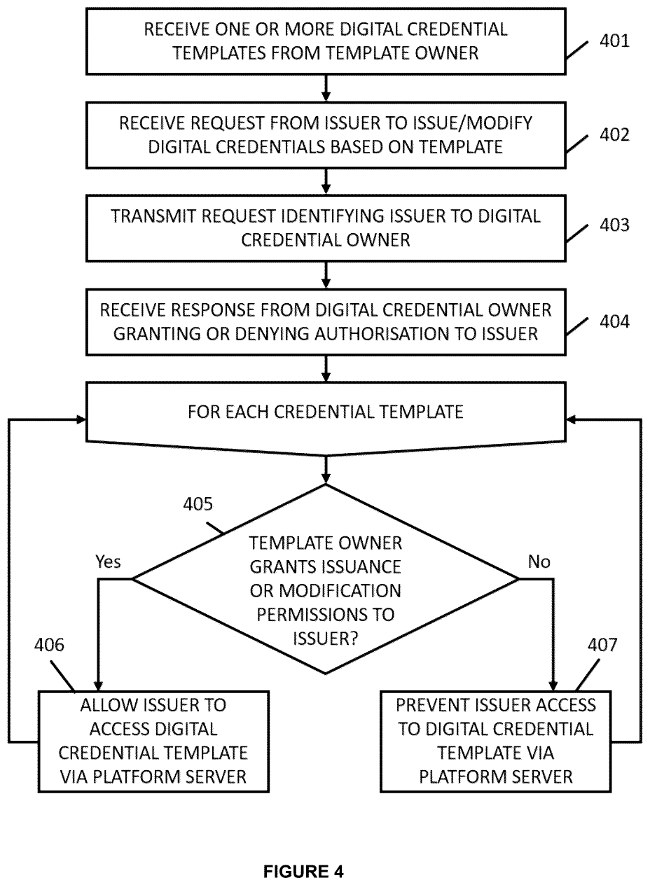

Referring now to FIG. 4, a flow diagram is shown illustrating a process of authorising digital credential issuers to generate digital credentials based on particular digital credential templates. As described below, the steps in this process may be performed by one or more components in the digital credential tracking and notification system 300 described above. For example, each of steps 401-407 may be performed by the digital credential platform server 310, in communication with one or more template owner systems 320 and one or more digital credential issuer systems 330. However, in other examples, one or more of the steps in this process may be performed by a template owner system 320 or an issuer system 330. It should also be understood that the various features and processes described herein, including receiving digital credential templates and implementing template-specific access to various authorised issuers, need not be limited to the specific systems and hardware implementations described herein, but also may be performed on the various other systems and hardware implementations described herein.

In step 401, a platform server 310 may receive one or more digital credential templates from one or more template owner systems 320. As discussed above, the digital credential templates received from template owner systems 320 may be an electronic document or data structure storing a general (e.g., non-user specific) description of a specific type of digital credential that may be issued to an individual. Such templates may include a description of the skills, proficiencies, and/or achievements that the digital credential represents, along with the parent organisation (i.e., the digital credential template owner) and various additional credential template field/metadata. Although step 401 describes receiving credential templates from a single template owner system 320, the platform server 310 may be configured to receive one or more templates from multiple different template owner systems 320. The received templates may be stored in a credential template repository (e.g., database) within a digital credential data store 315 maintained by the platform server 310. In some embodiments, credential templates may include secure and/or encrypted data, and thus encryption and/or various secure network communication techniques and protocols for transmitting templates from the template owner systems 320 to the platform server 310 in step 401. Such techniques may include, for example, security features and/or specialised hardware (e.g., hardware-accelerated SSL and HTTPS, WS-Security, firewalls, etc.), use of secure data transmission protocols and/or encryption, such as FTP, SFTP, and/or PGP encryption. SSL or TLS protocols, along with HTTP or HTTPS, also may be used to provide secure connections between the template owner systems 320 to the platform server 310, to provide authentication and data security.

In step 402, the platform server 310 may receive a request from an issuer system 330 to be designated an authorised issuer of digital credentials based on one or more of the credential templates stored by platform server 310. In some embodiments, the platform server 310 may provide a graphical user interface through which issuer systems 330 may review and request access to any available templates stored within the platform. Additionally or alternatively, the request in step 402 may be received programmatically (e.g., via API calls) by a service executing on the platform server 310. In either case, the request from the issuer system 330 may specify one or more particular credential templates stored by platform server 310. In some cases, different templates specified in the request may be owned by or associated with different template owners, rather than the issuer system 330 requesting all templates from the same owner. Additionally, the request may specify certain of the templates associated with a particular owner, while not specifying other templates associated with the same owner. Further, although step 402 describes receiving a request from a single issuer system 330, the platform server 310 may be configured to communicate with multiple independent issuer systems 330, each of which may request access to different (or the same) combinations of credential templates from various template owners.

In step 403, the platform server 310 may generate a request to one or more template owner systems 320, based on the request received from the issuer system 330 in step 402. For, example, the platform server 310 may initially identify the template owner systems 320 to be contacted, based on the particular templates specified in the request from the issuer system 330, along with a set of preferred communication techniques defined by each template owner system 320. Such communication techniques may indicate network addresses, protocols, notification types (e.g., email, SMS, service- or application-based, etc.) and the like for communicating requests to the template owner system 320. The platform server 310 may then transmit a properly formatted request to each template owner system 320, indicating the identity of the requesting issuer, and which of the owner's templates the issuer would like permissions to access and issue digital credentials based on.

As noted above, in some cases, multiple requests may be transmitted in step 403 to multiple different template owner systems 320. Each request may include only the credential templates owned by the particular owner system 320, for which the issuer system 330 has requested access. For instance, if the issuer system 330 selected and requested access to six different credential templates in step 402, the platform server 310 may determine in step 403 that the six credential templates are owned by three different templates owners, and may transmit a first request to a first template owner system 320a requesting access to three specific templates on behalf of the issuer, a second request to a second template owner system 320b requesting access to two different specific templates on behalf of the issuer, and a third request to a third template owner system 320c requesting access to one additional specific template on behalf of the issuer. Further, the digital credential tracking and notification system 300 may enable a user to save a selection of differential credential templates (as, for example, a credential pack) prior to step 402 if their access is commonly requested by the issuer system 330.

In step 404, the platform server 310 may receive responses back from one or more template owner systems 320, to the one or more requests sent in step 403. The generation of responses by the template owner systems 320 may be manual (e.g., decided by a template owner administrator) or determined and transmitted automatically based on predetermined criteria for granted requests from issuers. In either cases, the responses received by the platform server 310 may indicate that the template owner system 320 has fully granted the request, partially granted the request (i.e., granted the issuer access to some of the requested templates but not others), or denied the request. Additionally or alternatively, a template owner system 320 may transmit back a request for additional information about the issuer, in which case the platform server 310 may retrieve and transmit the additional requested information back to the template owner system 320, and may then receive a second response from the template owner system 320. In still other cases, the a template owner system 320 may transmit back an alternative proposal, in the form of a different set of templates that the requesting issuer may be granted access, in which case the platform server 310 may relay the alternative proposal back to the issuer system 330 and await a response from the issuer system 330.

In steps 405-407, the platform server 310 may perform an iterative process in which the appropriate authorisation data is recorded into the digital credential data store 315, for each credential template for which the issuer system 330 requested access. In step 405, if the template owner has granted access to the issuer, to issue and/or modify digital credentials based on the template (405: Yes), then in step 406 the platform server 310 may record the updated authorised issuer data in the data store 315. For example, an authorised issuer database, table, or other data repository may be updated to record the association of the requesting issuer with the specific template. On the other hand, if the template owner has not granted access to the issuer, to issue digital credentials based on the template (405: No), then in step 407 the platform server 310 may prevent issuer from accessing the requested template. In some embodiments, the platform server 310 may update a denied template list for each issuer, while in the other embodiments preventing access may be accomplished by sampling not creating a record in the data store 315 affirmatively granting template access to the issuer.

Thus, the techniques described in this example provide support for implementing template-level access to individual digital credential issuers, using the platform server 310 both as a communication intermediary and as a security safeguard to prevent the unauthorised access of credential templates by issuer systems 330. By providing template-level access, owner systems 320 and issuer systems 330 may collaborate to provide the issuer with access to certain specific templates of the owner, while not allowing access the issuer to access other templates of the same owner. Additionally, issuer systems 330 may use a single point of contact (i.e., the platform server 310) to request and receive access to a diversified portfolio of credential templates owned by several different template owners. In various embodiments, issuer systems 330 need not know the specific identities, network addresses, or communication preferences of the corresponding template owner systems 320, and vice versa.

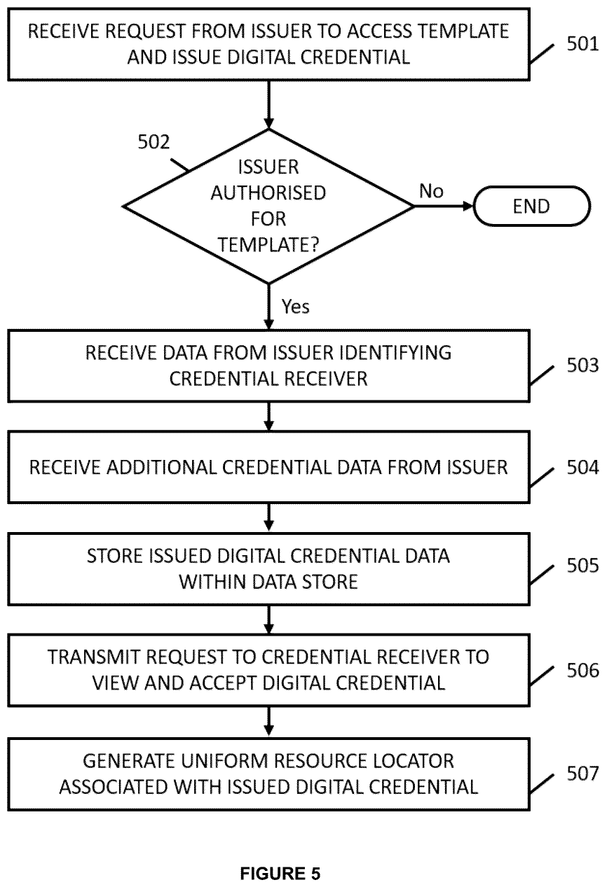

Referring now to FIG. 5, a flow diagram is shown illustrating a process of generating (or issuing), storing, provisioning, and modifying a digital credential based on digital credential template. As discussed above in reference to FIG. 4, the platform server 310 may store and manage the authorisation (or lack of authorisation) of specific credential issuers to issue digital credentials based on different digital credential templates. In this example process, a credential issuer requests to generate a digital credential based on a particular credential template. Accordingly, the steps in this process may be performed by the digital credential platform server 310, following the steps of FIG. 4, in communication with a digital credential issuer system 330.

In step 501, the platform server 310 may receive a request from a credential issuer system 330 to access a specified credential template in order to generate (or create, issue, or modify) a digital credential. In some embodiments, the platform server 310 may provide a graphical user interface (e.g., web-based) through which issuer systems 330 may issue and/or modify digital credentials. Additionally or alternatively, the request in step 501 may be received programmatically (e.g., via API calls) by a service executing on the platform server 310. In either case, the request from the issuer system 330 in step 501 may identify at least the issuer making the requesting (e.g., including a username and password and/or other authentication credentials associated with the issue for validation), as well as the specific template for which the issuer is requesting access.

In step 502, the platform server 310 may determine whether or not the issuer making the request is authorised to access the specific template identified in the request. As discussed above, the platform server 310 may maintain updated authorised issuer data in the data store 315, for example, in an authorised issuer database, table, or other data repository. Thus, in step 502, the platform server 310 may retrieve the authorised template data for the issuer, to determine if the issuer is authorised to issue and/or modify digital credentials based on the specified template. If the issuer is not authorised (502: No), the process ends and no digital credential may be issued.

Assuming the issuer is authorised to issue and/or modify digital credentials based on the specified template (502: Yes), the issuer may provide data identifying the credential receiver in step 503. The credential receiver (or credential earner or badge earner) corresponds to an individual that has been determined by the issuer to be eligible to receive a digital credential based on the template. For example, the credential receiver may be an individual user of an electronic learning system, professional training system, online certification course, or the like, who has completed a predetermined set of eligibility requirements and/or successfully completed a qualification test to receive a credential in accordance with the template. The receiver identification data received in step 503 may include, for example, the individual's name, contact information (e.g., email address, phone number, etc.) and/or various other identifying data such as a login identifier, system account number, student number, social security number, etc.

In addition to the receiver identification data received in step 503, the issuer system 330 may provide the platform server 310 with additional data necessary (or optional) for generating a digital credential for the credential receiver. The additional data received in step 504 may depend on the credential template, as different templates may include different data fields requiring different information before a digital credential may be issued and/or modified. Such additional data may include, for example, as issue date for the digital credential, an (optional) expiration date for the digital credential, and/or user-specific evidence which may be embedded or provided as links that provides additional supporting documentation (e.g., transcripts, diplomas, scanned assignments or exam documents, certification letters, reference letters, licenses, identification documents, signed certificates of completion, etc.). The data received in steps 503 and 504 may be transmitted by the issuer system 330 separately or in the same transmission. In some cases, the data may be received in steps 503 and 504 via an interactive graphical user interface provided by the platform server 310. Additionally or alternatively, such data may be received via a programmatic interface (e.g., API calls), or as a network request, or via an invocation of an application or service executing on the platform server, etc.

As noted above, each template owner may designate, for each credential template owned by the owner, one or more digital credential issuers to be authorised issuers of digital credentials based on the template. In such cases, in accordance with the different fields or characteristics of the template document/data structure, template owner may be designated as the credential issuer (e.g., in a first metadata field not editable by the issuer system 330), while the authorised issuer may be designated as the credential provider (e.g., in a second metadata field editable by the issuer system 330). However, for some templates, the template owner may grant access to some (or all) of the authorised issuers of the template to be identified within the digital credential data as the credential issuer. In such cases, any credentials issued based on the template may appear to all credential viewers (e.g., any user requesting/receiving credential data) to be issued solely by the authorised issuer, and the template owner might not be identified in any credential data and/or any user-facing credential graphic views. For instance, based on the document or structure of the credential template, the template owner may remain anonymous to credential earners in some cases, and in other cases the template owner may be listed only as an endorser. The permissions designated from template owners to authorised issuers, to be listed as the credential issuer, may be granted for specific templates and/or for specific template-issuer combinations. For example, a template owner may generate and maintain a first template for which every authorised issuer of the first template is granted permissions to be listed as the credential issuer. However, in other cases, the template owner may, for a particular template, grant permissions for only certain authorised issuers to be listed as the credential issuer, whereas other authorised issuers are not granted these permissions and thus will not be listed as the issuer of digital credentials based on the template.

In addition to granting permissions for certain authorised issuers to be identified as the credential issuer (rather than the credential provider), certain embodiments may provide template owners the ability to grant other types of permissions to authorised issuers as well. For example, a template owner may grant a particular authorised issuer permission to edit an icon image, description, skill set list, and other credential data defined in the template. Similar to the above example, such permissions may be granted by template owners to all authorised issuers of a certain template, or only to some specific authorised issuers of the template. These grants of permission by template owners may be received and enforced by the platform server 310. For example, the platform server 310 may provide various interfaces (e.g., graphical and/or programmatic interfaces) to template owner systems 320 when templates are uploaded from the template owner system 320 to the data store 315. These interfaces also may be accessible to template owner systems 320 at later times, allowing template owners to review and modify to various permissions granted to different authorised issuers.

In step 505, the platform server 310 may issue and store a new digital credential for the credential receiver, based on the data provided by the issuer system 330. In some embodiments, the digital credential may be generated as a new electronic document or data structure instance based on the credential template, after which the user identification data received in step 503, and any additional data received in step 504, may be inserted into the new template instance, thereby customising the template instance to create the new digital credential with the receiver's user data. The newly issued digital credential may be stored in the digital credential data store 315, for example, in a digital credential database or repository.

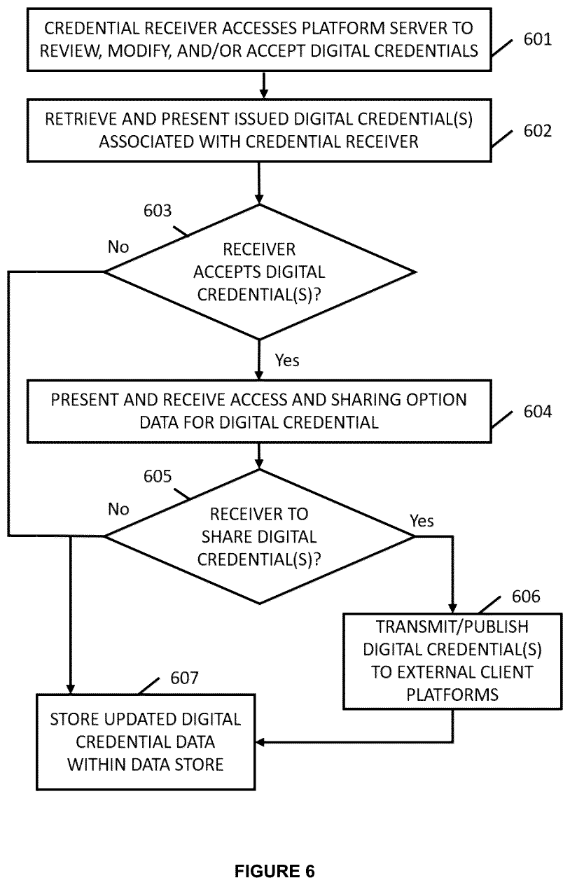

In step 506, following a successful issuance of a new digital credential, the platform server 310 may transmit a notification and request to the receiver of the digital credential, allowing the credential earner to accept and/or share the digital credential. In some embodiments, the platform server 310 may use the user contact information received in step 503 (e.g., email address, phone number, etc.) to transmit the notification and request to the appropriate receiver system 340. The process by which a credential earner may respond to the request, by accepting and/or sharing the credential, is discussed in more detail below in reference to FIG. 6.

In step 507, the platform server 310 may provision the new digital credential by generating a unique uniform resource locator (URL) corresponding to the digital credential. The unique URL may reference a valid location within platform server 310 or a separate related web server within the system 300. As discussed in more detail below, the creation and support of a unique URL for each digital credential may allow external users to access and view any digital credential earned by any receiver, and also allows the platform server 310 to record, track, and analyse views the different digital credentials.

In various embodiments, one or both of steps 506 and 507 may be optional, may depend upon one another, and/or may be performed in the opposite order. For instance, in some cases, a new digital credential may be created and/or modified without transmitting a request to the credential receiver system 340, and also without provisioning the new digital credential. In other cases, one but not the other of these steps may be performed. For example, the platform server 310 may be configured not to provision the new digital credential until after the digital credential has been reviewed and accepted by the credential receiver. In still other cases, an issuer may transmit a particular flag (e.g., an “infrastructure mode” flag) or select a corresponding option when issuing the digital credential, indicating that the credential receiver has not created a platform account or is otherwise unable to access the platform server 310 in order to accept and/or share the new digital credential. When the platform server 310 receives the particular flag or option from the issuer system 330, the server 310 may respond by not transmitting the request to the credential receiver system 340, and instead automatically provisioning the new credential (e.g., generating the unique public URL corresponding to the credential) immediately after the issuance of the credential.

Referring now to FIG. 6, another flow diagram is shown illustrating a process of initiating the acceptance, modification and sharing of digital credentials by a credential receiver (or credential earner). As discussed above in reference to FIG. 5, the platform server 310 may transmit a notification and request to a credential receiver 340 in response to the issuance of a new digital credential for the receiver. In this example process, the credential receiver using system 340 accesses the platform server 310 in order to provide instructions to the platform server 310 with respect to the accepting/rejecting a newly issued and/or modified credential, and with respect to sharing/not sharing the credential. Accordingly, the steps in this process may be performed by the digital credential platform server 310, following the steps of FIG. 5, in communication with a credential receiver system 340.

In step 601, the platform server 310 receives a request from a credential receiver system 340 to review and/or accept one or more digital credentials issued to the credential receiver (or earner). In some examples, the request in step 601 may be received in response to the transmission sent by the platform server 310 in step 506. The request in step 601, along with the subsequent interactions between the platform server 310 and the credential receiver system 340 in steps 602-606, may be performed via graphical user interface (e.g., web-based) provided by the platform server 310. In such cases, the credential receiver may access and authenticate to the web-based interface, and then may navigate through the various menus of the interface to initiate the acceptance and/or sharing of the receiver's digital credentials.

In step 602, after the credential receiver has been successfully authenticated as the valid receiver, the platform server 310 may retrieve and present data (e.g., via a graphical interface) corresponding to the digital credentials issued and/or modified to the receiver. In some embodiments, the presentation of digital credentials and/or the restricted interface that allows receivers to accept and/or share digital credentials, may be treated as secure data by the platform server 310. Thus, encryption and/or various secure network communication techniques and protocols may be used for transmitting the digital credentials and/or interface components to the receiver system 340 in step 602. As discussed above, such techniques may include, for example, security features and/or specialised hardware, use of secure data transmission protocols and/or encryption, and the like, to provide authentication and data security.

In step 603, the platform server 310 may receive an indication from the credential receiver whether or the not receiver accepts the issued and/or modified credential. The indication in step 603 may be received via an interactive graphic interface provided by the platform server 310 to the receiver client device 340, or via a programmatic interface (e.g., API call), a notification (e.g., email or SMS), or any other communication techniques. If the receiver opts not to accept the issued and/or modified credential (603: No), then the platform server 310 may terminate the communication session with receiver system 340 (or move to the next credential issued and/or modified to the receiver), and in step 607, may set the status of the digital credential within the data store 315 to indicate that the receiver did not accept the credential.

If the receiver indicates that the issued and/or modified credential will be accepted (603: Yes), then the platform server 310 may present additional data in step 604 (e.g., via a subsequent menu in the graphical interface) with options to allow the receiver to designate an access level associated with credential (e.g., public or private), and to allow the receiver to share (or publish) the digital credential to various recipients or platforms. Additionally, in some embodiments, the acceptance of a credential by the receiver (603: Yes) also may trigger the platform server 310 to provision the credential, by generating and storing a unique public URL associated with the credential.

If the credential receiver opts not to share the digital credential (605:No), then the platform server 310 may terminate the communication session with receiver system 340 (or move to the next credential issued and/or modified to the receiver), and in step 607, may set the status the digital credential within the data store 315 to indicate that the receiver accepted but did not share the credential. Instead, if the receiver opts to share the digital credential (e.g., via email to certain recipients, or via one or more social networking platforms) (605: Yes), then in step 606 the platform server 310 may provide the appropriate user interface components to allow the user to email or post the digital credential to the receiver's selected sharing/publishing options. In some embodiments, any transmission sharing a digital credential (e.g., emails, posts, profile updates, etc.) may include the unique public URL associated the credential, in order to allow the platform server 310 to receive and track views of the credential (e.g., clicks or access attempts to the unique URL). After the digital credential has been shared/published in step 606 in accordance with the receiver's selections, then in step 607, the platform server 310 may set the status the digital credential within the data store 315 to indicate that the receiver accepted and shared the credential. Additionally, in this case, step 607 may include recording the detailed sharing metrics for the credential in a credential tracking database or repository of the data store 315. The additional detailed sharing metrics stored and tracked by the platform server 310 may include, for example, the time that a digital credential was accepted and/or shared, the geographic location from which a digital credential was accepted and/or shared, the communication network or web domain from which a digital credential was accepted and/or shared, the sharing technique(s) (e.g., email, social networking post, tweet, profile update, etc.), the individual recipients and the social network platform to whom the credential was shared, the web domains and/or business segments of the individual recipients to whom the credential was shared, etc.

In various embodiments, some or all of the above data metrics may be determined by the platform server 310 and stored in the digital credential data store 315 for each instance of an acceptance, modification and/or sharing of a credential. Additionally, when the sharing of a digital credential involves the transmission of the unique public URL associated with the credential, the sharing may result in subsequent views of the credential (e.g., clicks or access attempts to the unique URL). The platform server 310 (and/or related servers) may provide receive requests to view credentials, for example, HTTP requests directed to one or more of the unique public URLs corresponding to a user's credentials, and may respond to the requests with credential information (e.g., a credential/badge view web-based user interface, etc.). In some embodiments, a unique URL corresponding to a digital credential may be directed to a unique network resource supported by the platform server 310. Additionally or alternatively, a unique URL may be directed to a non-unique network resource, but may be unique by virtue of one or more unique URL parameters, and/or may include other unique message header or body data identifying one or more specific digital credentials. As the present invention may be embodied in several forms without departing from the essential characteristics of the invention, it should be understood that the above described embodiments should not be considered to limit the present invention but rather should be construed broadly. Various modifications, improvements and equivalent arrangements will be readily apparent to those skilled in the art, and are intended to be included within the spirit and scope of the invention. The present embodiments are, therefore, to be considered in all respects as illustrative and not restrictive.

1. A credential tracking and notification system comprising:
a digital credential template owner device, comprising:
a processing unit comprising one or more processors;
one or more network interfaces configured to transmit secure data to a digital credential platform server; and
memory coupled with and readable by the processing unit and storing therein a set of instructions which, when executed by the processing unit, causes the digital credential template owner device to:
transmit one or more digital credential templates to the digital credential platform server:
receive requests from the digital credential platform server to confirm authorised issuers of digital credentials based on one or more of the digital credential templates; and
in response to said requests, transmit secure data confirming one or more digital credential issuers as authorised issuers and/or modifiers of digital credentials based on one or more of the digital credential templates:
a digital credential issuer device, comprising:
a processing unit comprising one or more processors;
one or more network interfaces configured to transmit secure data to the digital credential platform server; and
memory coupled with and readable by the processing unit and storing therein a set of instructions which, when executed by the processing unit, causes the digital credential issuer device to:
respond to requests from the digital credential platform server to request permission to update the status of digital credentials based on one or more of the digital credential templates associated with one or more digital credential template owners;
receive responses to said requests from the digital credential platform server, said responses confirming a digital credential issuer associated with the digital credential issuer device as an authorised issuer and/or modifier of digital credentials based on one or more of the digital credential templates associated with one or more digital credential template owners;
access, from the digital credential platform server, a first digital credential template for which the digital credential issuer is authorised to issue and/or modify digital credentials;
determine that a first credential receiver is eligible to receive a digital credential based on the first digital credential template;
update the status of a first digital credential based on the first digital credential template and data confirming a status change of the first digital credential; and
transmit data confirming the status of the first digital credential to the first credential receiver, and to the digital credential platform server; and
a digital credential platform server, comprising:
a processing unit comprising one or more processors;
one or more network interfaces configured to transmit secure data to the digital credential platform server; and
memory coupled with and readable by the processing unit and storing therein a set of instructions which, when executed by the processing unit, causes the digital credential platform server to:
receive one or more digital credential templates, including the first digital credential template, from the digital credential template owner device associated with a digital credential template owner, the first digital credential template corresponding to an educational or training certification defined by the digital credential template owner:
store the received one or more digital credential templates in a secure storage of the digital credential platform server;
transmit, to the digital credential issuer device associated with the digital credential issuer, an automated status request requesting the current status of digital credentials based on the first digital credential template:
receive, in response to said transmitted request, from the digital credential issuer device, data confirming the status change of the first digital credential, the first digital credential representing completion of the educational certification or training course by a credential recipient:
transmit, to the digital credential template owner device, a request corresponding to the automated status request issued to the digital credential issuer to modify digital credentials based on the first digital credential template:
receive, in response to said transmitted request, from the digital credential template owner device, authorisation data permitting the digital credential issuer to issue and/or modify digital credentials based on the first digital credential template:
in response to the received authorisation data, grant the digital credential issuer device access to the first digital credential template;
transmit a communication to a first receiver device associated with the first credential receiver, in response to receiving the data from the digital credential issuer device confirming the current status of the first digital credential;
output a user interface during a network session with the first credential receiver device, the user interface including a notification regarding the current status of the first digital credential; and
store the data corresponding to the first digital credential, including data indicating the current status of the first digital credential, in the secure storage of the digital credential platform server.

2. The credential tracking and notification system of claim 1, the memory of the digital credential platform server storing therein further instructions which, when executed by the processing unit, causes the digital credential platform server to:
receive, from the digital credential template owner device, additional authorisation data permitting the digital credential issuer to be named as a providing entity within digital credentials issued by the digital credential issuer based on the first digital credential template;
store, in association with the first digital credential, data indicating that the digital credential issuer was the provider of the first digital credential;
receive a request for the first digital credential from a client device; and
retrieve and output the data corresponding to the first digital credential, including the data indicating that the digital credential issuer was the provider of the first digital credential, in response to the request.

3. The credential tracking and notification system of claim 1, the memory of the digital credential platform server storing therein further instructions which, when executed by the processing unit, causes the digital credential platform server to:
receive, from a credential endorser device, additional authorisation data permitting a first a credential endorser to be named as an endorsing entity for digital credentials issued and/or modified based on the first digital credential template;
store, in association with the first digital credential, data indicating that the endorsing entity endorses the first digital credential;
receive a request for the first digital credential from a client device; and
retrieve and output the data corresponding to the first digital credential, including the data indicating that the endorsing entity endorses the first digital credential, in response to the request.

4. The credential tracking and notification system of claim 1, wherein the received selection of the first credential receiver is a selection to accept the first digital credential, and wherein the memory of the digital credential platform server stores further instructions which, when executed by the processing unit, causes the digital credential platform server to:
in response to the acceptance of the first digital credential by the first credential receiver, generate a uniform resource locator (URL) associated with the first digital credential.

5. The credential tracking and notification system of claim 1, wherein the digital credential platform server receives a plurality of digital credential templates from the digital credential template owner device, including the first digital credential template and a second digital credential template, and wherein the memory of the digital credential platform server storing therein further instructions which, when executed by the processing unit, causes the digital credential platform server to:
receive, from the digital credential template owner device, second authorisation data denying permission to the digital credential issuer to issue and/or modify digital credentials based on the second digital credential template; and
in response to the received authorisation data and second authorisation data, grant the digital credential issuer device access to the first digital credential template but prevent the digital credential issuer device from accessing the second digital credential template.

6. The credential tracking and notification system of claim 1, the memory of the digital credential platform server storing therein further instructions which, when executed by the processing unit, causes the digital credential platform server to:
receive, from the digital credential issuer device, additional data confirming an issuance and/or modification of a second digital credential based on a second digital credential template, wherein the first and the second digital credentials are received from the same digital credential issuer device, but wherein the first digital credential template is associated with a different digital credential template owner than the second digital credential template.

7. The credential tracking and notification system of claim 1, the memory of the digital credential platform server storing therein further instructions which, when executed by the processing unit, causes the digital credential platform server to:
identify a particular flag within the data received from the digital credential issuer device, confirming the issuance and/or modification of the first digital credential to the first credential receiver;
in response to the identification of the particular flag, generate a uniform resource locator (URL) associated with the first digital credential, wherein the URL is generated without receiving an indication of acceptance of the first digital credential by the first credential receiver; and
transmit the generated URL associated with the first digital credential to the digital credential issuer device.

8. The credential tracking and notification system of claim 1, the memory of the digital credential platform server storing therein further instructions which, when executed by the processing unit, causes the digital credential platform server to:
receive, from the digital credential template owner device, a template update for the first digital credential template; and
update the data corresponding to the first digital credential in the secure storage of the digital credential platform server, based on the template update received for the first digital credential template.

9. The credential tracking and notification system of claim 1, wherein storing the data corresponding to the first digital credential comprises storing an expiration date associated with the first digital credential, and wherein the memory of the digital credential platform server storing therein further instructions which, when executed by the processing unit, causes the digital credential platform server to:
monitor the expiration date associated with the first digital credential; and
in response to determining that the expiration date has passed, update the data corresponding to the first digital credential in the secure storage of the digital credential platform server to indicate that the first digital credential is expired.

10. The credential tracking and notification system of claim 1, the memory of the digital credential platform server storing therein further instructions which, when executed by the processing unit, causes the digital credential platform server to:
receive, from a client device associated with an endorsing entity, an update to an endorsement of the first digital credential template; and
update the data corresponding to the first digital credential in the secure storage of the digital credential platform server, based on the update to the endorsement of the first digital credential template.

11. A method of authorising issuers and/or modifiers of digital credentials, comprising:
receiving, by a digital credential platform server, one or more digital credential templates, including a first digital credential template, from a digital credential template owner device associated with a digital credential template owner, the first digital credential template corresponding to an educational or training certification defined by the digital credential template owner;
storing the received one or more digital credential templates in a secure storage of the digital credential platform server;
transmitting, by the digital credential platform server and to the digital credential template owner device, an automated status request requesting the current status of digital credentials based on the first digital credential template;
receiving, by the digital credential platform server, in response to said transmitted request, authorisation data permitting the digital credential issuer to issue and/or modify digital credentials based on the first digital credential template;
granting, by the digital credential platform server, the digital credential issuer device access to the first digital credential template, in response to the received authorisation data;
receiving, by the digital credential platform server, from the digital credential issuer device, data confirming issuance and/or modification of a first digital credential to a first credential receiver, the first digital credential representing completion of the educational certification or training course by the first credential receiver;
in response to receiving the data from the digital credential issuer device confirming the issuance and/or modification of the first digital credential, transmitting, by the digital credential platform server, a communication to a first receiver device associated with the first credential receiver;
outputting a user interface during a network session with the first credential receiver device, the user interface including a notification regarding the current status of the first digital credential; and
storing the data corresponding to the first digital credential, including data indicating the current status of the first digital credential, in the secure storage of the digital credential platform server.

12. The method of authorising issuers and/or modifiers of digital credentials of claim 11, further comprising:
receiving, from the digital credential template owner device, additional authorisation data permitting the digital credential issuer to be named as a providing entity within digital credentials issued by the digital credential issuer based on the first digital credential template;
storing, in association with the first digital credential, data indicating that the digital credential issuer was the provider of the first digital credential;
receiving a request for the first digital credential from a client device; and
retrieving and outputting the data corresponding to the first digital credential, including the data indicating that the digital credential issuer was the provider of the first digital credential, in response to the request.

13. The method of authorising issuers and/or modifiers of digital credentials of claim 11, further comprising:
receiving, from a credential endorser device, additional authorisation data permitting a first a credential endorser to be named as an endorsing entity for digital credentials issued based on the first digital credential template;
storing, in association with the first digital credential, data indicating that the endorsing entity endorses the first digital credential;
receiving a request for the first digital credential from a client device; and
retrieving and outputting the data corresponding to the first digital credential, including the data indicating that the endorsing entity endorses the first digital credential, in response to the request.

14. The method of authorising issuers and/or modifiers of digital credentials of claim 11, wherein the received selection of the first credential receiver is a selection to accept the first digital credential, the method further comprising:
generating a uniform resource locator (URL) associated with the first digital credential, in response to the acceptance of the first digital credential by the first credential receiver.

15. The method of authorising issuers and/or modifiers of digital credentials of claim 11, wherein the digital credential platform server receives a plurality of digital credential templates from the digital credential template owner device, including the first digital credential template and a second digital credential template, and wherein the method further comprises:
receiving, from the digital credential template owner device, second authorisation data denying permission to the digital credential issuer to issue and/or modify digital credentials based on the second digital credential template; and
in response to the received authorisation data and second authorisation data, granting the digital credential issuer device access to the first digital credential template but preventing the digital credential issuer device from accessing the second digital credential template.

16. The method of authorising issuers and/or modifiers of digital credentials of claim 11, further comprising:
receiving, from the digital credential issuer device, additional data confirming an issuance and/or modification of a second digital credential based on a second digital credential template, wherein the first and the second digital credentials are received from the same digital credential issuer device, but wherein the first digital credential template is associated with a different digital credential template owner than the second digital credential template.

17. The method of authorising issuers and/or modifiers of digital credentials of claim 11, further comprising:
identifying a particular flag within the data received from the digital credential issuer device, confirming the issuance and/or modification of the first digital credential to the first credential receiver;
in response to the identification of the particular flag, generating a uniform resource locator (URL) associated with the first digital credential, wherein the URL is generated without receiving an indication of acceptance of the first digital credential by the first credential receiver; and
transmitting the generated URL associated with the first digital credential to the digital credential issuer device.

18. The method of authorising issuers and/or modifiers of digital credentials of claim 11, further comprising:
receiving, from the digital credential template owner device, a template update for the first digital credential template; and
updating the data corresponding to the first digital credential in the secure storage of the digital credential platform server, based on the template update received for the first digital credential template.

19. The method of authorising issuers and/or modifiers of digital credentials of claim 11, wherein storing the data corresponding to the first digital credential comprises storing an expiration date associated with the first digital credential, and wherein the method further comprises:
monitoring the expiration date associated with the first digital credential; and
in response to determining that the expiration date has passed, updating the data corresponding to the first digital credential in the secure storage of the digital credential platform server to indicate that the first digital credential is expired.

20. The method of authorising issuers and/or modifiers of digital credentials of claim 11, further comprising:
receiving, from a client device associated with an endorsing entity, an update to an endorsement of the first digital credential template; and
updating the data corresponding to the first digital credential in the secure storage of the digital credential platform server, based on the update to the endorsement of the first digital credential template.
